(19) United States
(12) Patent Application Publication
(10) Pub. No.: US 2025/0052930 A1
(43) Pub. Date: Feb. 13, 2025

(54) Unitary Multi-Optic Systems with Optical Barriers

(71) Applicant: MagWerks Vision Inc., Oxford, MI (US)

(72) Inventors: Michael F. Pickholz, Oxford, MI (US); Steven Francis Tregilgas, Oxford, MI (US)

(21) Appl. No.: 18/921,572

(22) Filed: Oct. 21, 2024

Related U.S. Application Data
(63) Continuation-in-part of application No. 18/379,949, filed on Oct. 13, 2023, now Pat. No. 12,124,056.
Application No. 18/379,949 is a continuation of application No. 17/363,473, filed on Jun. 30, 2021, now Pat. No. 11,815,701.
(60) Provisional application No. 63/047,367, filed on Jul. 2, 2020.

(51) Int. Cl. G02B 3/00; F21S 41/143; F21S 41/26; F21S 41/32; F21S 43/31; F21V 7/00

(52) U.S. Cl. CPC G02B 3/0031; F21S 41/143; F21S 41/26; F21S 41/32; F21S 41/322; F21S 43/315; F21V 7/0091; G02B 3/0056

(57) ABSTRACT

A multi-optic system has a unitary lens with two or more co-molded individual optics molded such that each individual optic is adjacent at least one other individual optic, each individual optic configured to be illuminated with a respective radiation source, and a skirt extending from a perimeter of the front surface of the unitary lens. An optical-blocking barrier is positioned between adjacent individual optics and configured to prevent transmission of undesired source emissions between the adjacent individual optics. A substrate on which radiation sources are carried and at least one of the skirt and the optical-blocking barrier enclose the multi-optic system.

### CROSS-REFERENCE TO RELATED APPLICATION(S)

This application is a continuation-in-part of U.S. patent application Ser. No. 18/379,949, filed on Oct. 13, 2023, which is a continuation application of U.S. patent application Ser. No. 17/363,473, filed Jun. 30, 2021, now U.S. Pat. No. 11,815,701, which claims priority to and the benefit of U.S. Provisional Patent Application Ser. No. 63/047,367, filed Jul. 2, 2020, the entire disclosures of which are hereby incorporated by reference.

### TECHNICAL FIELD

This disclosure relates to the multi-optic systems having multiple optics molded together in one lamp with optical barriers positioned between the optics. The multi-optic lamps may be utilized for illumination, signalization and/or broadcast of light energy, employing optical systems to harness and direct the optical output of LEDs, laser-based light sources, light bulbs, High Intensity Discharge (HID) lights and/or any other source producing light output, whether in the visible or non-visible spectra, towards a defined area and/or pattern.

### BACKGROUND

Optical lenses engineered to harness and direct sources of light are produced with basic techniques devised to tailor light output. Since the 1980's, plastic lenses have steadily replaced glass as the transparent outer enclosure for lighting applications in most fields. Historically, plastic lenses have been produced from rigid materials, such as, but not limited to, polycarbonate (PC), poly(methyl methacrylate) (PMMA), polystyrene (PS), cyclic olefin polymer (COP), cyclic olefin copolymer (COCP).

These materials are essentially rigid in nature, not substantially deforming under applied pressure or through the force of gravity. Once properly fixed and in place, such materials essentially retain their geometric configuration. However, there are many disadvantages to the use of plastic for optical lenses, particularly in the automotive field.

### SUMMARY

Disclosed herein are embodiments of a unitary multi-optic system that enables the use of individual optics each with its own illumination source to be a unitary piece while preventing stray light from adjacent optics. The optical-blocking barriers also act as a structural scaffold to support the co-molded optics when molded from optical silicone.

One embodiment of a multi-optic system as disclosed herein has a unitary lens with two or more co-molded individual optics molded such that each individual optic is adjacent at least one other individual optic, each individual optic configured to be illuminated with a respective radiation source. The unitary lens includes a skirt extending from a perimeter of the front surface of the unitary lens. An optical-blocking barrier is positioned between adjacent individual optics and configured to prevent transmission of undesired source emissions between the adjacent individual optics. A substrate on which radiation sources are carried and at least one of the skirt and the optical-blocking barrier enclose the multi-optic system.

Another embodiment of a multi-optic system has a unitary lens comprising two or more co-molded individual total internal reflection (TIR) optics molded such that each individual optic is adjacent at least one other individual optic, each individual optic configured to be illuminated with a respective radiation source, and an optical-blocking barrier positioned between the two or more co-molded individual TIR optics and around a perimeter of the two or more co-molded individual TIR optics, the optical-blocking barrier configured to interfere with transmission of undesired source emissions between the two or more co-molded individual TIR optics.

In another aspect, the unitary lens may have a flexible skirt of the optical silicone that extends from a front surface of the unitary lens.

In another aspect, a mounting substrate may be configured to carry one or more of a light source, a circuit board, and heat sink, one or both of the skirt and the optical-blacking barrier extending rearward from the front surface of the unitary lens to contact the mounting substrate to enclose the unitary lens with the mounting substrate.

Also disclosed is a vehicle, comprising an exterior component having an aperture and a multi-optic system as disclosed herein, wherein the unitary lens is sized to fit within the aperture such that an edge of the aperture contacts the skirt, the mounting substrate located internal to the exterior component.

These and other embodiments and aspects are contemplated herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a front perspective view of an embodiment of a unitary, multi-optic system having different optical prescriptions as disclosed herein.

FIG. 1B is a cross-sectional view of FIG. 1A along line B.

FIG. 1C is a rear perspective view of FIG. 1B.

FIG. 2A is a rear perspective view of another embodiment of a unitary, multi-optic system having the same optical prescriptions as disclosed herein.

FIG. 2B is a cross-section view of FIG. 2A along line B.

FIG. 3A is a partial plan view of FIG. 1A including the radiation/light source and pattern.

FIG. 3B is the partial plan view of FIG. 3A but without the optical-blocking barriers, illustrating the stray light contamination.

FIG. 3C is the partial plan view of FIG. 3A with the optical-blocking barriers in the unitary multi-optic systems disclosed herein, illustrating the focused emission pattern.

FIG. 4 is a front perspective view of a optical silicone lens with a reinforcing grid as disclosed herein.

FIG. 5A is a front perspective view of another optical silicone lens with a reinforcing grid as disclosed herein.

FIG. 5B is a cross-section view of FIG. 5A along line B.

FIG. 6 is a front perspective view of another optical silicone lens with a reinforcing grid as disclosed herein.

FIG. 7 is a front perspective view of another embodiment of an optical silicone lens with a reinforcing grid as disclosed herein.

FIG. 8 is a partial plan view of a reinforcing grid with a heating element as disclosed herein.

FIG. 9 is a front view of a unitary lens as disclosed herein.

FIG. 10 is a front, lest perspective view of the unitary lens of FIG. 9.

FIG. 11 is an exploded view of a multi-optic system as disclosed herein.

FIG. 12 is a rear view of FIG. 9.

FIG. 13 is an optical-blocking barrier as disclosed herein.

FIG. 14 is a front view of the multi-optic system as disclosed herein.

FIG. 15 is a front view of the multi-optic system mounted to a vehicle.

FIG. 16 is a rear view of FIG. 15.

FIG. 17 is a schematic of a vehicle with the multi-optic systems as disclosed herein.

FIG. 18 is a cross-sectional view of another aspect of the multi-optic systems as disclosed herein.

FIGS. 19A and 19 B are schematics of the multi-optic system of claim 18 mounted to a vehicle component and flexing with alignment of the multi-optic system.

### DETAILED DESCRIPTION

Optical prescription lenses are typically individually molded to obtain the desired prescription, and each lens has its own radiation source. When multiple lenses are used in an application, such as an automobile application, the lenses are assembled in a housing and each lens is individually aimed. As a non-limiting example, an optical prescription lens can be formed for headlights or taillights, with another optical prescription lens formed for fog light and yet another optical prescription lens formed for a turn signal. The optical prescription lenses are typically made of glass or rigid plastic. On systems utilizing individual optical lenses, stray light is usually captured within the lamp and usually prevented from exiting the lamp in an uncontrolled, undesired manner. As used herein “prescription” refers to an optic or a lens that is designed to meet certain specification with regard to light or radiation pattern and intensity, and is road legal.

Co-molding of plastics to form multiple optical lenses as a single unitary array has been employed in some industrial and consumer applications where light “bleeding” between the individual optics is non-critical and can be tolerated. While such unitary arrays achieve sufficient optical efficiency for the industrial and consumer applications, the optical efficiency typically remains under 50%. Stray light from the light source, which is not harnessed by the optical system, will impinge the adjacent optic at odd, undesired angles, thereby creating stray, uncontrolled light as well, further compounding the problem. For multiple applications which do not fall under specific regulation or need to meet specific photometric requirements, the issue is largely manageable as well as tolerable.

There is interest in the use of co-molded optical lens arrays in applications such as automotive and other vehicles, where optical regulations have specific specifications, such as regulatory specifications regulated by the National Highway Traffic Safety Administration (NHTSA). Co-molded unitary optical lens arrays can reduce the size and the weight of the same array formed with individually molded lenses because the housing requirements are reduced. Furthermore, when different prescription optics are molded in a unitary piece, the mold ensures that the alignment of each prescription optic lens with respect to each other and the overall application is precise producing the specified light output and pattern. The secondary adjustment/alignment that is required with individually molded optic lenses may not be needed with the co-molded array. However, co-molding of plastics to form multiple optical lenses as a single unitary array has not been used for regulated optic applications such as automotive applications at least in part due to the issue of stray light. At issue is the optical coupling, which takes place when lenses are conjoined or co-molded into a unitary element comprising multiple optical elements forming an optical system, as light will propagate between one optic and the conjoined/adjacent one in an uncontrolled manner. In co-molded (molded as one) optical lenses, stray light can readily emanate from 1) the radiation (or light) source, 2) the optical system itself, the light existing in an uncontrolled matter, or 3) from one optic lens to adjacent optic lenses through the walls of the co-molded optic lenses in the array. For example, total internal reflection (TIR) optics are not totally efficient in harnessing light, hence light will escape and enter adjacent or adjoining optics thereby creating unintended optical aberrations. Stray light emanating from one optical element and/or source can adversely compromise the performance of an adjacent optical element as stray, uncontrolled light enters an adjacent optical element and propagates, then exits the adjacent optical element in an uncontrolled manner. The stray light can degrade and impair sought after optical performance as well as entail the possibility of failing to achieve specific optical performance requirements. Stray, uncontrolled light is unacceptable or may lead to non-compliance of optical regulation specifications.

Disclosed herein are embodiments of a unitary multi-optic lens comprising co-molded multiple optical elements. Also disclosed is a lamp comprising the unitary multi-optic lens and a radiation source provided in each optical element. The optical elements of the unitary multi-optic lens can all be of the same prescription or can be of different prescriptions. The unitary multi-optic lens also includes an optical-blocking barrier integrally molded with or inserted between and/or around the multiple optical elements, the optical-blocking barrier positioned between between adjacent optical elements so as to prevent transmission of emissions from the radiation source between the adjacent optical elements. The optical-blocking barrier can also be co-molded or inserted at exterior surfaces of the unitary multi-optic lens, including end surfaces and top and bottom surfaces, to prevent transmission of emissions from the radiation source through the outer walls of each optical lens.

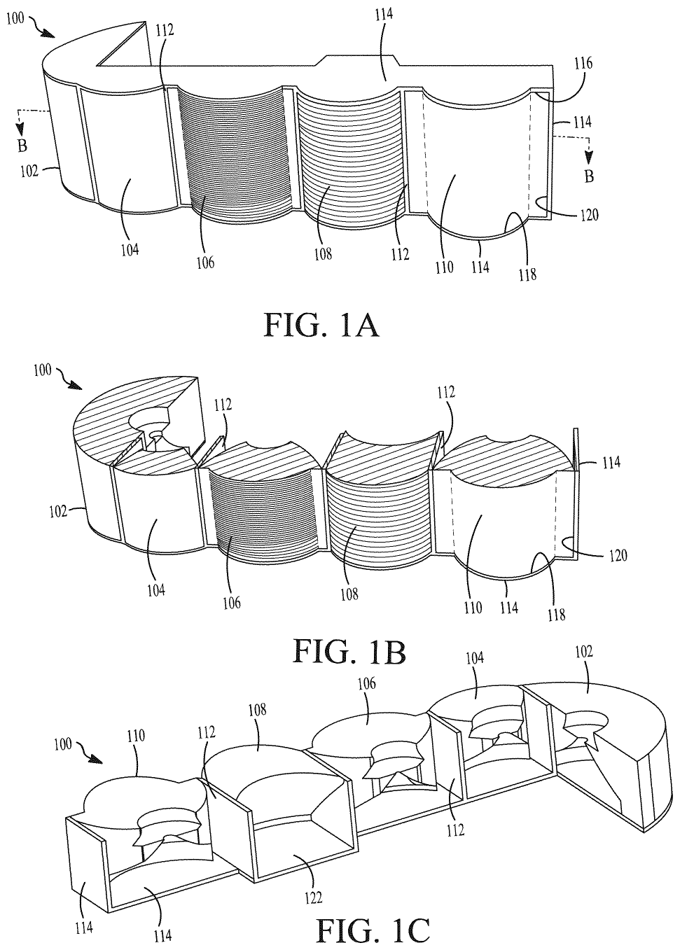

FIG. 1A illustrates a unitary multi-optic system molded as a unitary—or monolithic—piece whereby each individual optical prescription addresses a specific individual illumination function whose performance may be adversely impacted by stray light emanating from an adjacent light or radiation source. The unitary multi-optic system is, for illustration, an automotive headlamp system whereby all the various elements are molded as a unitary, co-molded, single piece multi-optic system 100. Each individual prescription, such as the side-emitting light optic 102, the turn signal optic 104, the primary low beam optic 106, the secondary low beam optic 108, and the high beam optic 110, must meet stringent optical output criteria, which otherwise can be adversely compromised by stray, uncontrolled light emanating from one illuminated source, entering an adjacent one, then exiting in a manner which adversely impacts the sought optical objectives and/or optical requirements.

To eliminate the stray light, enabling the use of co-molded optics for regulated systems such as automotive lamps, the unitary multi-optic system 100 further incorporates optical-blocking barriers 112 co-molded with the optics, the optical-blocking barriers 112 positioned between adjacent optics. Additional optical-blocking barriers 114 may be included on the periphery of the unitary multi-optic system 100, on one or more of the top surface 116, bottom surface, 118 and side surface(s) 120. FIG. 1B is a cross-section view of FIG. 1A along line B. FIG. 1C is a rear view of the cross-section shown in FIG. 1B. As illustrated in FIGS. 1B and 1C, the optical-blocking barriers 112, 114 can extend beyond the surfaces of the optics, beyond the body of the optic itself, to block airborne stray light from the associated light source or any other exterior source. The degree if extension can vary depending on the housing in which the unitary multi-optic system 100 will be held, the application and/or position of the unitary multi-optic system 100, for example. This is illustrated with the optical-blocking barrier 122 associates with the secondary low beam optic 108.

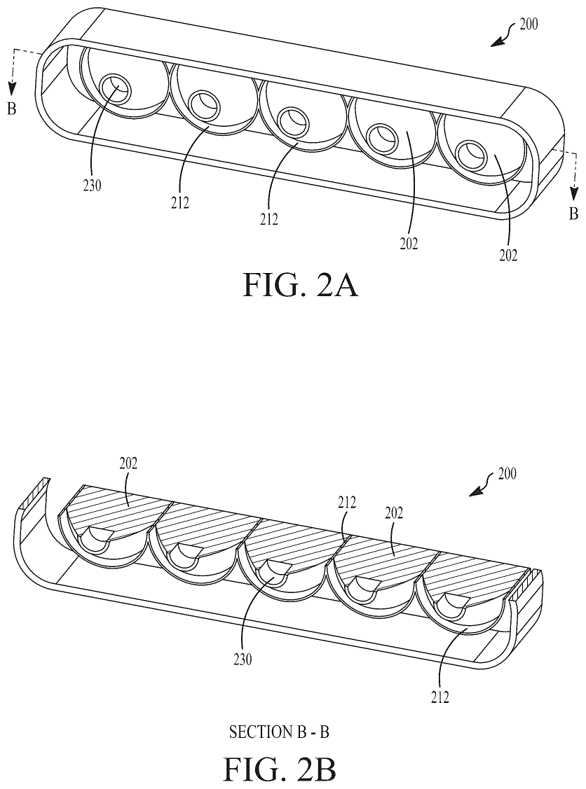

For illustrative purposes, FIG. 2A illustrates a unitary multi-optic system 200 molded as a unitary—or monolithic—piece whereby each individual optic 202 has the same prescription. To eliminate the stray light, enabling the use of co-molded optics for regulated systems such as automotive lamps, the unitary multi-optic system 200 further incorporates optical-blocking barriers 212 co-molded with the optics 202, the optical-blocking barriers 212 in this embodiment positioned between adjacent optics 202 by circumscribing each optic 202. The optical-blocking barrier 212 can completely circumscribe the optic 202 or can partially circumscribe the optic 202 so long as stray light is prevented from contaminating an adjacent optic. The optical-blocking barrier 212 can extend beyond the body of the respective optic 202 as necessary, typically extending beyond one or both of a rear or side surface of the body, and each optical-blocking barrier 212 can individually, selectively extend. FIG. 2B is a cross-section view of FIG. 2A along line B. As with FIGS. 1A-1C, the radiation/light source is not shown, but each optic 202 is illustrated with a receiving portion 230 which would receive the light/radiation from the source or would receive the source itself.

The unitary multi-optic systems 100, 200 will be understood by those skilled in the art to have utility in numerous, various applications, including, without limitation, battery and motor vehicles (including automobiles, trucks, aircraft, watercraft, recreational vehicles, off-road vehicles, motorized bikes and mopeds, quads, three-wheelers, and the like), non-motorized vehicles such as bicycles, aerospace, and fixed indoor and outdoor lighting applications (e.g., street lighting, parking garage lighting). As already noted, the unitary multi-optic systems 100, 200 can be used in regulated applications such a vehicle exterior lighting. Although illustrated to show one row of optics, any configuration in which multiple optics can be molded together with an optical-blocking barrier between adjacent optics is contemplated. As non-limiting examples, the optics could be stacked one upon another and the optics could be set in multiple rows.

The optic material can be optical silicone or a plastic such as PC, PMMA, PS, COP and COCP, as examples. The optical-blocking barriers 112, 114, 212 can be made from one or more suitable opaque materials, such as an opaque plastic, including but not limited to opaque versions of PC, PMMA, PS, COP, and COCP, an opaque silicone, and stainless steel, low alloy steel, sheet steel, tool steel, titanium, cobalt, copper, magnetic metal, hard-metal, refractory metal, ceramic, magnesium, sheet magnesium, injection molded magnesium, aluminum, sheet aluminum, and/or magnesium/aluminum alloy, brass, and copper, as non-limiting examples. The optical-blocking barriers 112, 114 can be fitted into the unitary mold and molded with the optic material or insert-molded once the optic material is poured. The optical-blocking barriers can be inserted into the already-molded multi-optic lens. The optical-blocking barriers can be produced through any well-known technique such as, but not limited to, plastic injection molding, stamping, casting or thixomolded magnesium construction. The optical-blocking barriers would be precisely placed inside the unitary optical mold with optic material over-molding the barrier, thereby achieving a unitary lens construction with an integrated set of light blocking partitions within.

As an alternative to plastic, optical silicone can be used as the optic material in the unitary multi-optic systems 100, 200 disclosed herein. Optical silicone provides many advantages over the rigid plastic typically used in lenses.

Common plastic lenses require the application of external anti-UV coatings in order to preclude the degradation of the plastic, which otherwise rapidly turns opaque, greatly reducing the functional performance as well as adversely impacting the appearance of the product. Such products commonly have a limited performance lifespan, leading to often severe optical degradation with extended sunlight (UV) exposure, a clear negative for products frequently or continually exposed to sun. Optical silicone is impervious to UV radiation damage. Optical silicone testing has demonstrated resistance to UV damage in excess of 10 years in direct sun exposure. No anti-UV coating is needed with optical silicone.

Conventional plastic lenses, particularly those used on vehicle exteriors, require hard coatings in order to mitigate the rapid surface degradation brought about by foreign object impingement, occurring, for example, during travel. Optical silicone has an inherent resistance to gravel and other road debris impingement. The soft, rubber-like properties of optical silicone are such that, rather than imbedding and/or damaging the surface of the plastic lenses, the energy is absorbed within the optical silicone without adversely affecting the optical clarity of the material, with the debris simply bouncing-off without imparting physical damage to the optic silicone material.

Plastics used to make lenses shrink while cooling, which leads to the loss of critical optical shape definition as the material pulls away from the desired tool optical geometry. This can be particularly pronounced in large molds, with large optical lens volumes leading to undesirable deformations in other critical optic areas. The industry has sought to address such issues via multi-step molding solutions, whereby lenses are produced via successive molding “steps” thereby accumulating material in subsequent molding operations so as to control shrink and thereby deliver accurate as-molded optical performance. Such processes are inherently expensive, given the multi-shot nature of the molding equipment.

Optical silicone can be molded/formed accurately in a large format optic with no sink or other optical aberrations and in a single mold process. Optical silicone optics are formed with a thermoset process, which utilizes a catalyst along with heat input to cure the optic into its final configuration. Rather than shrink, silicone effectively expands during the molding process, thereby enabling a highly accurate replication of the optical surface, including very thin optical elements in a single molding step.

Yet another advantage of using optical silicone is its significantly higher temperature resistance than other common optical-grade plastics, which make optical silicone particularly useful in LED applications where close proximity between the optical element and the LED source is functionally advantageous. Such close proximity between LEDs and conventional plastic lenses is often precluded due to the thermal degradation brought about by high temperatures on plastic optics, for instance. Silicone optics can thus be placed directly over high temperature LED sources, thereby significantly improving optical performance while precluding damage over time, a critical functional advantage.

Optical silicone is rubber-like in nature. Being both soft as well as flexible, it differs significantly from other forms of optical grade materials, such as glass and rigid plastics, and such flexibility contributes to the advantages already described. This flexibility introduces other advantages as well (e.g., the ability to incorporate flexible elements, the ability to incorporate significant “undercuts”, which otherwise would prevent plastics to be removed from the mold without incorporating mold action, the ability to significantly deform yet return to its as-molded shape, having a higher temperature resistance, etc.) Yet, the lack of structural rigidity makes the use of optical silicone impractical or unsuitable for many applications, such as large optics and for thin areas.

The rubber-like nature of optical silicone precludes the direct replacement of rigid plastics in many applications, such as those requiring thin lenses covering a myriad of lighting products, ranging from flashlights to automotive headlamps. While readily moldable, silicone optics molded in conventional plastic lens geometries simply prove too soft as well as deformable, both through direct mechanical input as well as gravity, rendering them unsuitable as direct substitutes for rigid optical plastic materials. While silicone can be molded as a thin lens, the inherent lack of rigidity and deformability make silicones functionally unsuitable for such applications given that even low-level forces would readily overcome and deform such silicone lenses. Issues, such as optical misalignment or internal damage, can thus occur.

In the case of large silicone-based optics, where silicone must span large areas, the additional issues associated with mechanical deformation must also be addressed in order to make silicone practical for large lenses, which otherwise would deform under various forms of pressure, mechanical load, vibration or simply the impact of gravity.

To address these issues with optical silicone, and to reap the many benefits of the optical silicone lenses, the optical-blocking barriers 112, 114, 212 incorporated into the unitary multi-optic systems 100, 200 disclosed herein also act as structural mechanical reinforcement when the optic material is optical silicone. The optical-blocking barriers 112, 114, 212 overcome the mechanical limitations of the optical silicone, enabling its use in the unitary multi-optic systems 100, 200. The placement of the suitable inserted, insert-molded/co-molded optical-blocking barriers impart the silicone lens with sufficient mechanical strength so as only limited localized, acceptable deformation would take place. Given the superior shape memory associated with silicone, the lens would revert to its original un-deformed geometry once the external pressure is relieved, thereby allowing the use of optical silicone as an outer lens for such applications as, but not limited to, outer vehicular headlamps, tail lamps, signal lamps, auxiliary lamps as well as a myriad of non-automotive lighting applications in industry, transportation, construction, security as well as multiple illumination and signalization fields. Furthermore, the unitary multi-optic systems herein made with optical silicone would require no UV coating and no hard coating on light emitting surfaces to avoid damage.

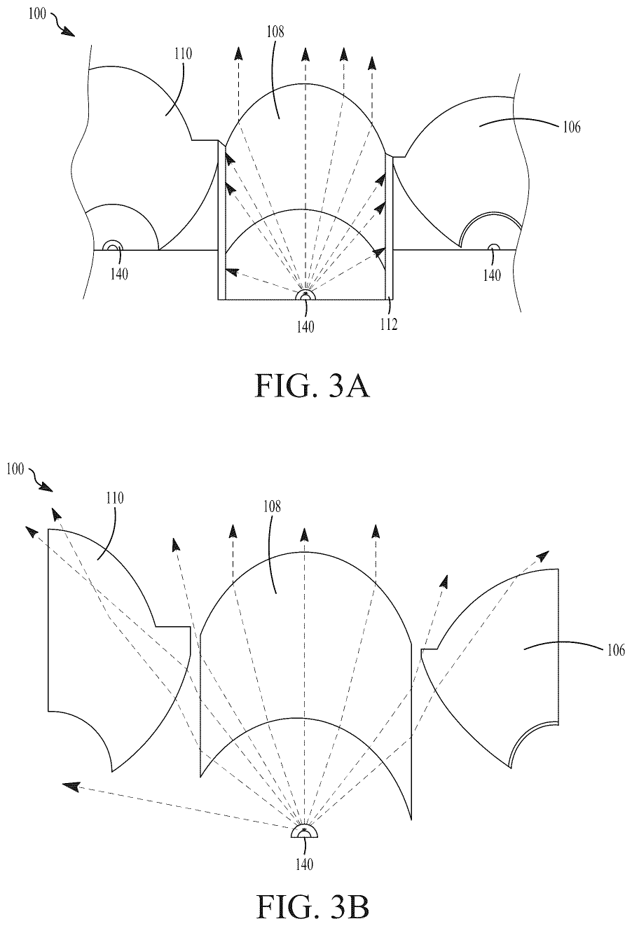

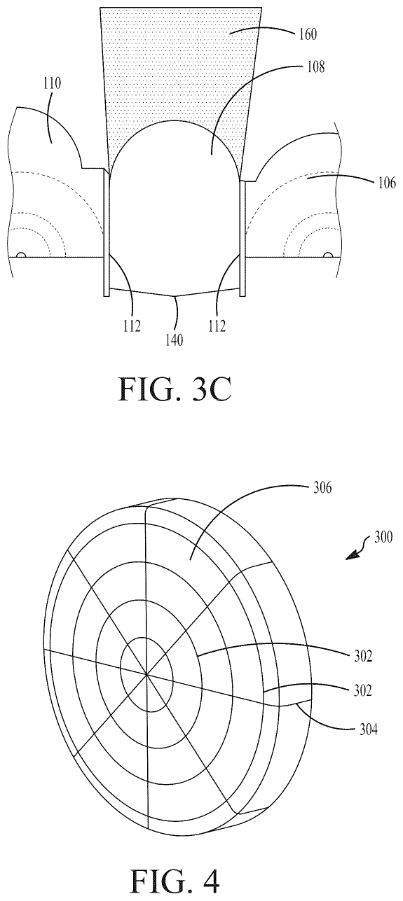

Returning back to the figures, FIG. 3A is a plan view cross-section of the illustration in FIG. 1A illustrating the configuration of the primary low beam optic 106, the secondary low beam optic 108, and the high beam optic 110 of the unitary multi-optic system 100. In this particular illustration, the individual optic prescriptions are aimed to achieve a legally constrained photometric output. The radiation/light sources 140 are indicated for each illustrated optic.

FIG. 3B illustrates a similar plan view section as that of FIG. 3A, except that in FIG. 3B, only the co-molded optics are present. There are no optical-blocking barriers in this example. FIG. 3B includes the radiation/light source 140 for optic 108. Reference 150 illustrates the useful emissions from source 140, which enter optic 108 and provide the intended optical input to achieve the desired optical performance for optic 108. Conversely, references 152 and 154 illustrate the pathway by which uncontrolled emissions associated with source 140 enters and impinges on the adjacent optics 106, 110 in an uncontrolled, undesired manner. The emissions may be produced by a multiplicity of sources in a variety of wavelengths, whether in the visible domain or not, examples of sources 140 including but not limited to, LEDs, laser emitters, optically-piped systems, halogen, High Intensity Discharge (HID)/xenon, tungsten, etc.

In the illustration in FIG. 3B, as the optical requirements for optic 110 make its optical collection efficiency (i.e., the amount of useful light collected by the optic and rendered onto effective, useful optical output) quite low, less than 50%, a substantial amount of radiation energy thus impinges on the adjacent optics resulting in uncontrolled light being harnessed and emitted by these optics as undesired optical output. In this particular example a legal threshold of 125 candela is assigned to an objective glare value, the maximum intensity allowable for this particular optic at this particular objective test point/criteria, in this case a low beam headlamp. The optical impact associated with the uncontrolled radiation 152 emanating from the source 140 illuminating optic 108, then entering optic 110 and optic 106, then exiting these adjacent optics as uncontrolled radiation. Furthermore, additional uncontrolled light is transmitted between the optics in the areas where these are conjoined, where commonly molded sections abut to each other (see reference 154) allowing further uncontrolled light to be transmitted between the adjacent as well as further afield-positioned optics forming part of the unitary optical system depicted without the optical-blocking barriers. Stray light thus has multiple pathways to bleed into and penetrate the various adjoining optical elements. Output results in the glare measurement for this particular example exceed 3500 candela, hence significantly beyond the legal criteria allowed by law, thereby illustrating that the outlined unitary optical construction, absent the embodiments of the unitary multi-optic system as disclosed, is neither practical nor feasible in most such applications.

Similar optical interactions exist between all the conjoined elements depicted in this example, which comprises of multiple optical prescriptions, which must meet specific optical performance objectives to either fulfill requirements or legal guidelines. Effectively, illuminating any single or multiple function will entail stray light to enter the adjacent optical elements and thereby adversely impact the effective intended performance of each specific optic and/or optical system. Such constraints illustrate how those skilled in the art of optics do not consider conjoined optics, particularly those of dissimilar nature, as a practical approach. Effectively, the industry typically employs a single or multiple set of optics when these optics contribute to achieve a single optical pattern via the additive contribution of multiple individual sub-optics. In such applications, where interference from uncontrolled light bleed between adjacent optical elements is considered acceptable and/or manageable, multiple co-molded optical elements represent a practical solution yet, as evidenced by the example of FIG. 3B, diverse conjoined optical prescriptions is not practical in use for many applications.

FIG. 3C is an illustration of the light distribution associated with the light/radiation source 140 linked with optic 108 according to the embodiments of the unitary multi-optic systems disclosed herein, illustrating the effect of the optical-blocking barriers 112. FIG. 3C illustrates how a conjoined optical system can be produced so that each individual prescription operates as optically intended, without unwanted, performance altering radiation reaching adjacent optical elements. FIG. 3C illustrates how the optical-blocking barriers 112 effectively block cross-linking of light from penetrating adjacent optics, whether via airborne or through internally transmitted light or radiation beams 160 where the optics are conjoined. The uncontrolled glare produced without the optical-blocking barriers illustrated in FIG. 3B is eliminated, enabling the optic to perform as a stand-alone optical entity unburdened by stray radiation outputs resulting from uncontrolled emissions associated with adjacent or nearby optical elements. This illustration exemplifies how the unitary multi-optic systems disclosed herein can fulfill optical performance objectives via allowing each optic to perform as intended without undesired input or interference from other nearby optic prescription or features, enabling use of co-molded prescription optics even in regulated applications.

An example application of the unitary multi-optic systems disclosed herein are vehicle exterior lamps. A vehicle exterior lamp as disclosed herein comprises the unitary multi-optic system with two or more co-molded individual optics molded such that each individual optic is adjacent at least one other individual optic, each individual optic configured to be illuminated with a respective individual radiation source. An optical-blocking barrier is integrally molded with the individual optics and configured to prevent transmission of undesired source emissions between the two or more co-molded individual optics. The lamp further has one or more light sources associated with each co-molded individual optic and a housing configured to attach the unitary multi-optic system to an exterior of the vehicle.

As previously noted, optical silicone has many advantages over conventional plastic lenses. The shape memory following the stretching and bending of silicone material makes it practical to mold undercuts and other such features, which are either not practical with harder plastics or require the use of complex tool action in order to physically extract the molded component without damaging the parts. Another advantage is the near-imperviousness of optical silicone to UV exposure inasmuch as UV is not absorbed by the silicone, and so does not affect its properties over long periods of time. Yet another advantage is its resistance to damage from stones, gravel, etc. that typically score, scratch and other damage conventional plastic lenses.

However, the rubber-like flexibility renders large or thin lenses prone to deformation due to external forces such as gravity, external mechanical pressure, aerodynamic pressure, vibrations, etc. In general, while optical silicone can be effectively molded to thicknesses significantly thinner than is practical for common hard plastic optical materials, such as PC and PMMA, the low mechanical strength of silicone makes it impractical for applications such as external lamp lenses, subject to a multiplicity of external forces, which would result in undesired lens deformations. The embodiments illustrated in FIGS. 4-7 impart structural strength to thin lens materials made with optical silicone and other soft hardness materials that may be used to produce lamp lenses.

A conventional plastic lens is generally molded in thicknesses ranging from 2.50 mm to 3.00 mm, the lower figure representing a typical practical lower molding as well as mechanical strength limits of such optical plastics. Optical silicone can be molded as thin as 0.127 mm in cross section thickness, considerably thinner than its plastic counterparts.

FIG. 4 illustrates a thin optical lens 300. As a non-limiting example, the lens 300 may be a round vehicular lamp lens, such as a 7″ headlamp. The optical lens 300 is internally reinforced by a suitable mechanically strong reinforcing grid 302 which is insert molded within as well as fully captured within the silicone material rendering a final single, unitary lens. A grid extension 304 provides means to mechanically link the reinforcing grid to the lamp housing so as to provide a high degree of structural stability along with strength. The reinforcing grid 302 spans a main body 306 of the optical lens 300 to support the entirety of the optical lens 300 due to its thin constructions. The reinforcing grid 302 may be constructed from a variety of known materials, such as, but not limited to, thin wires, molded plastics, cast or molded metals, metal stampings and the like.

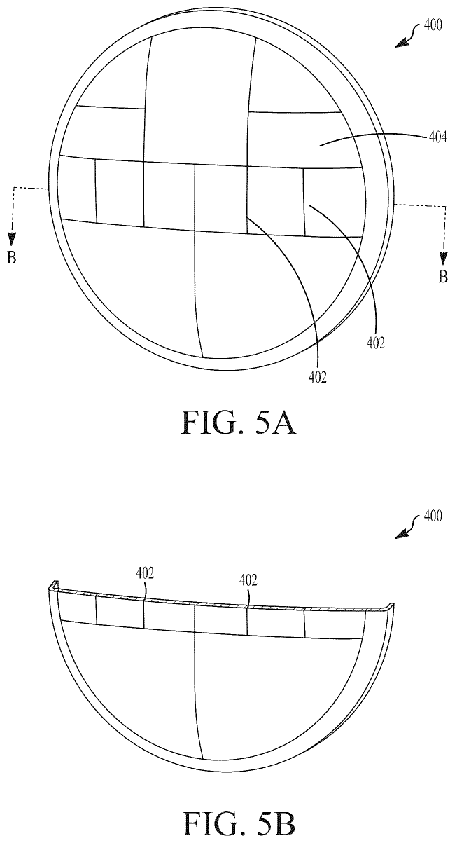

FIG. 5A illustrates a front perspective view of another lens 400 with an alternative reinforcing grid 402. The reinforcing grid 402 spans a main body 404 of the optical lens 400 to support the entirety of the optical lens 400 due to its thin constructions. In FIG. 5A, the reinforcing grid 402 is in a different configuration that is provided as an example only. The reinforcing grids 302, 402 can be of any design that provides sufficient structural support to the lens and may be selected based on aesthetics or other reasons. The reinforcing grid 302, 402 does not impact the performance of the lamp, whether prescription or not, due to the thinness of the grid material and its embeddedness. FIG. 5B is a cross section of FIG. 5A along line B.

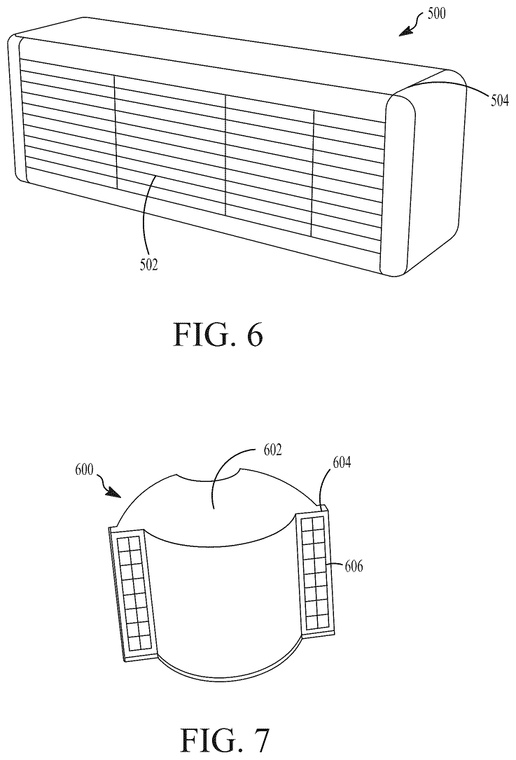

FIG. 6 illustrates yet another non-limiting example of a lens 500 having a different geometry and having the internally imbedded reinforcing grid 502 and structural grid extensions 504. The lamp lens disclosed herein can be used with one or more light/radiation (illumination) sources and can be used in non-prescription applications.

FIG. 7 illustrates another embodiment of an optic lens 600 formed of a silicone material. In this embodiment, the lens element includes a first portion 602 and a second portion 604, the second portion 604 having a smaller thickness than the first portion 602. The reinforcing grid 606 is only included in the second portion 606 due to the thinness of the second portion 604. The first portion 602 is of a thickness that does not require the reinforcing grid 606. The optical lens 600 is internally reinforced by the suitable mechanically strong reinforcing grid 606 which is insert molded within as well as fully captured within the silicone material rendering a final single, unitary lens. The shape of the first and second portions 602, 604, as well as the design of the reinforcing grid 606, are provided as examples and are non-limiting.

A growing trend within the automotive lighting field is to implement heating functions within lenses in order to cope with ice, frost and snow build-up on LED as well as other types of lighting devices. While traditional incandescent and halogen light sources tend to emit considerable amounts of radiant thermal energy, which oftentimes proves sufficient to melt snow, frost and ice to a level considered acceptable to maintain a suitable level of intended functionality and performance, LED light sources usually emit low levels of energy insufficient to accomplish a sufficient degree of defrosting and/or melting of ice, frost or snow, thereby leading to undesired build-up of ice, snow or frost, which effectively compromises the lamp light output and performance, oftentimes to levels significantly compromising performance and, in the case of vehicular and other applications, compromising safety. This issue is also associated with LED traffic lights, which unlike their incandescent technology predecessors, do not emit sufficient thermal emissions to accomplish effective ice, snow and frost melting resulting in many cases with the total blockage of the light signal in question.

Heating devices on LED headlamps with plastic lenses are available. The heating devices are incorporated onto the outer lamp plastic lenses via a variety of methods, such as adhesively applied heating grids to the inside of the outer lenses, grids printed onto suitable sheet materials then over-molded to form and outer lens, and wires partially melted onto the inside surface of the outer lens. However, conventional clear plastics are only temperature resistant up to around 100° C. For example, PC is temperature resistant to about 120° C. and PMMA is temperature resistant up to about 90° C.

As previously noted, optical silicone enjoys the added advantage of significantly higher temperature resistance than conventional clear plastics commonly employed for lighting applications. Silicones are usually rated to remain thermally stable to temperatures in the area of 200° C., which is nearly double that of traditional optical grade plastics. The higher temperature resistance provides the opportunity to use higher temperature heating elements to more rapidly defrost, de-ice and remove snow.

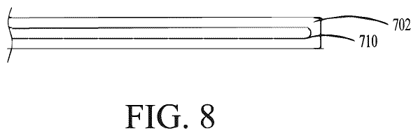

Although the conventional heating elements that are used with plastic lenses can be used with optical silicone lenses, the structural issues are not resolved with the heating elements, as they do not impart sufficient rigidity and mechanical support to the optical silicone. Accordingly, as disclosed herein, the reinforcing grids 302, 402, 502 in FIGS. 4-7 can be designed to function as a heating element to provide heat to the lens for removal of snow, frost, ice, etc., while still providing the structural support required for the thin lens. The reinforcing grids can be the heating element, made with sufficient mechanical strength to impart the structural support required by the optical silicone lens. Alternative, the reinforcing grids can be carriers for the heating element, with the heating element adhesively applied to the reinforcing grids, printed onto suitable sheet materials that are adhered to the reinforcing grids, printed to the reinforcing grids directly, or partially melted onto the surface of the reinforcing grid. The heating element can be energized through the application of electrical energy, leading to the internal heating of the element, which when conductively transmitted through the silicone lens, would result in the temperature of the lens rising above the melting point of ice, snow and frost. FIG. 8 is a non-limiting illustration of a reinforcing grid 702 carrying a heating element 710, shown as a wire.

It is further contemplated that the optical-blocking barriers in FIGS. 1-2 can be heating elements or heating element carriers, utilizing all barrier surfaces, some barrier surfaces, partial areas of all surfaces, or partial areas of some surfaces, for example.

Each individual optic of the multi-optic systems disclosed herein can be a TIR optic with no secondary light shaping optics. Each unitary lens of the multi-optic system may be made from optical silicone, which has many advantages as described herein, or may be made from conventional head lamp materials such as plastics and glass.

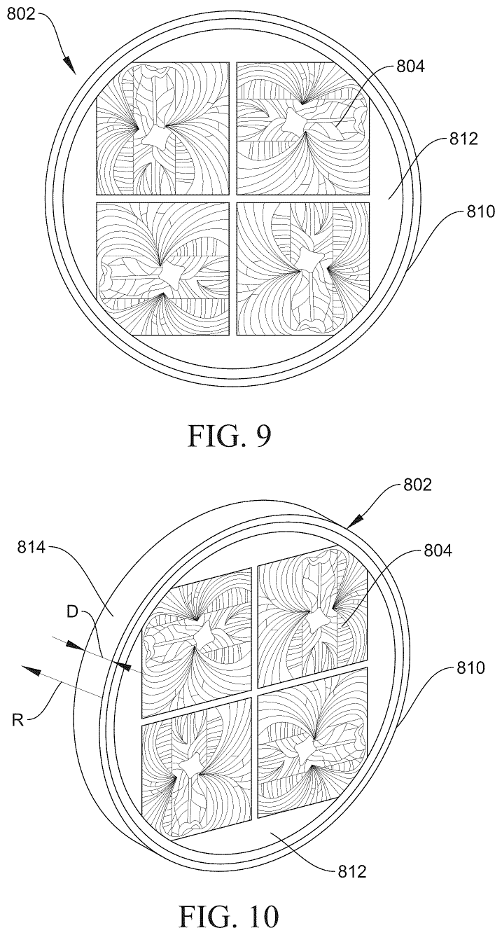

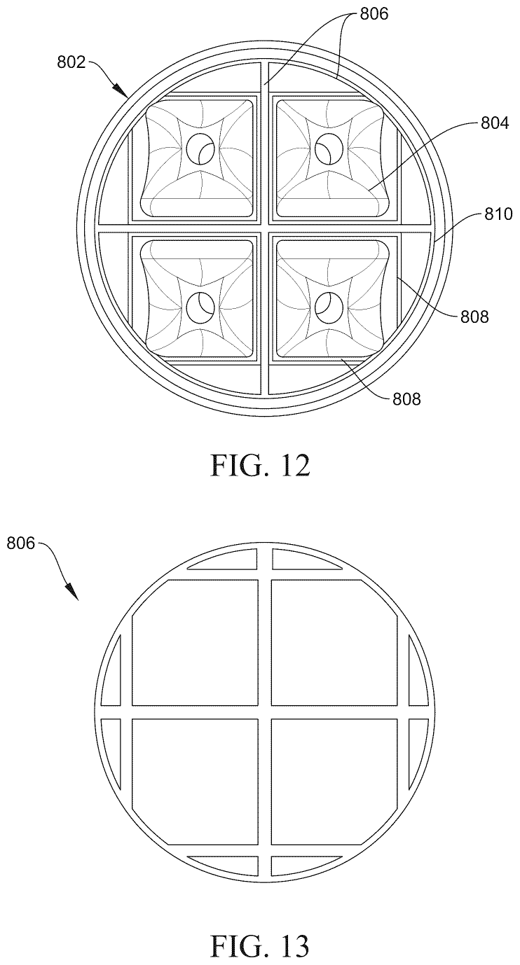

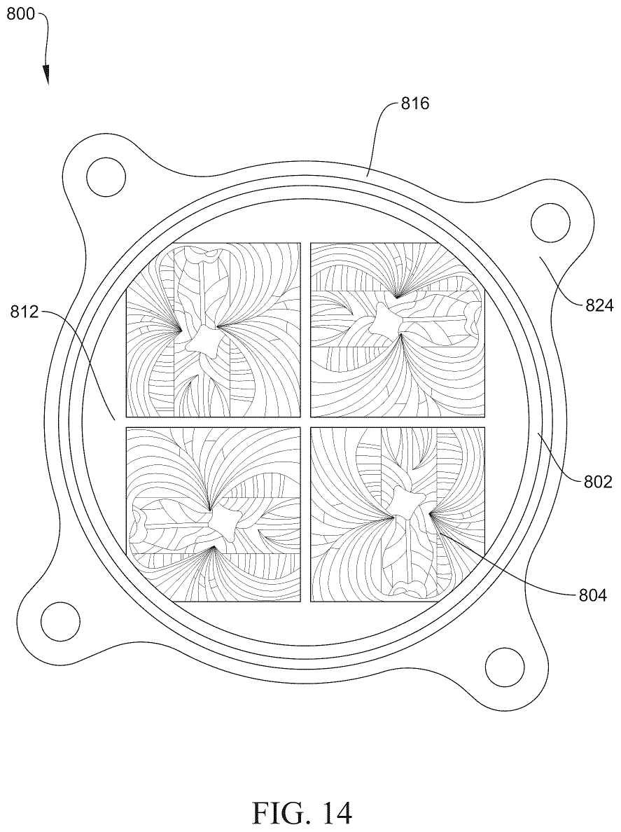

FIGS. 9-16 illustrate other aspects of the multi-optic systems disclosed herein. In one aspect of a multi-optic system 800, there is a unitary lens 802 having two or more co-molded individual optics 804 molded such that each individual optic 804 is adjacent at least one other individual optic, each individual optic 804 configured to be illuminated with a respective radiation source. An optical-blocking barrier 806 is positioned between adjacent individual optics 804 and configured to prevent transmission of undesired source emissions between the adjacent individual optics 804. The optical-blocking barrier 806 may also be positioned around a perimeter 808 of the two or more co-molded individual optics 804. The optical-blocking barrier may also or alternatively extend along a perimeter 810 of the unitary lens 802 to surround the two or more co-molded individual optics 804. This is illustrated in FIG. 12, in which the optical-blocking barrier 806 is inserted into the unitary lens 802 from behind, and FIG. 13, illustrating the optical-blocking barrier 806 alone. The optical-blocking barrier 806 may have a contoured portion that is contoured to align with the internal surfaces of one or more individual optics 804, leaving an opening aligned with the light source, thereby eliminating stray light sources from the circuit board.

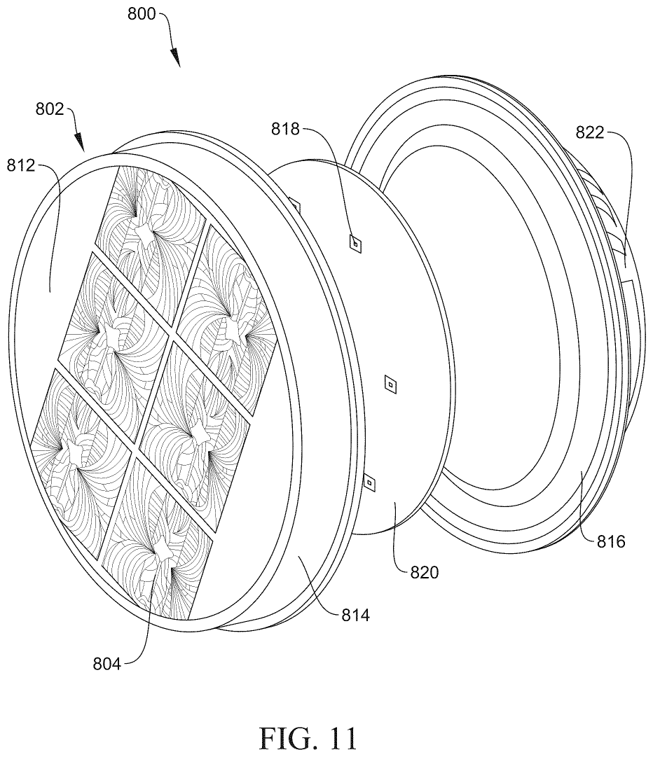

In this embodiment, the unitary lens 802 has a circular perimeter 810 and the individual optics 804 are side-by-side and stacked, as alternatives to optics 102-110 and 202. As noted, each individual optic can be a TIR optic. Four individual optics 804 are illustrated in FIGS. 9 and 10, while six individual optics 804 are illustrated in FIG. 11. This is not meant to be limiting. Two, three, five, seven and other numbers of individual optics are also contemplated. For example, the unitary lens 802 may have three co-molded individual TIR optics 804, with one optic providing a low beam function for a vehicle and two optics providing a high beam function for the vehicle. As another example, the unitary lens 802 may have four co-molded individual TIR optics 804, with two optics providing a low beam function for a vehicle and another two optics providing a high beam function for the vehicle. One or more of the co-molded optics can be types of optics other than TIR optics as well. As non-limiting examples, other optics may include turn signals, parking lights, etc.

As illustrated in FIGS. 9-11, the unitary lens 802 has a front surface 812 that includes the front surfaces of each individual optic 804. The unitary lens may further have a skirt 814 that extends from the front surface 812 of the unitary lens 802. The skirt 814 can be molded with the co-molded individual optics 804 to form the unitary lens 802. In one implementation, the skirt 814 extends rearward R from the front surface 812 of the unitary lens 802. The skirt 814 may extend around the entire perimeter 810 of the front surface 812 or may extend from only a portion or portions of the perimeter 810. The optical-blocking barrier 806 can have a depth substantially equal to a depth D of the skirt 814 to block illumination from escaping, and, if the skirt is made from optical silicone, to provide structural support to the skirt 814.

The multi-optic system 800 may also include a mounting substrate 816 configured to carry one or more of a light source 818, a circuit board 820, and heat sink 822. The mounting substrate 816 has one or more attachment members 824. One or both of the skirt 814 and the optical-blacking barrier 806 may extend rearward R from the front surface 812 of the unitary lens 802 to enclose the unitary lens 802 with the mounting substrate 816. The multi-optic systems disclosed herein can be made to fit conventionally sized apertures or non-conventionally sized apertures. Examples of conventional diameters include, but are not limited to, 7″ or 4.5″ diameters of apertures.

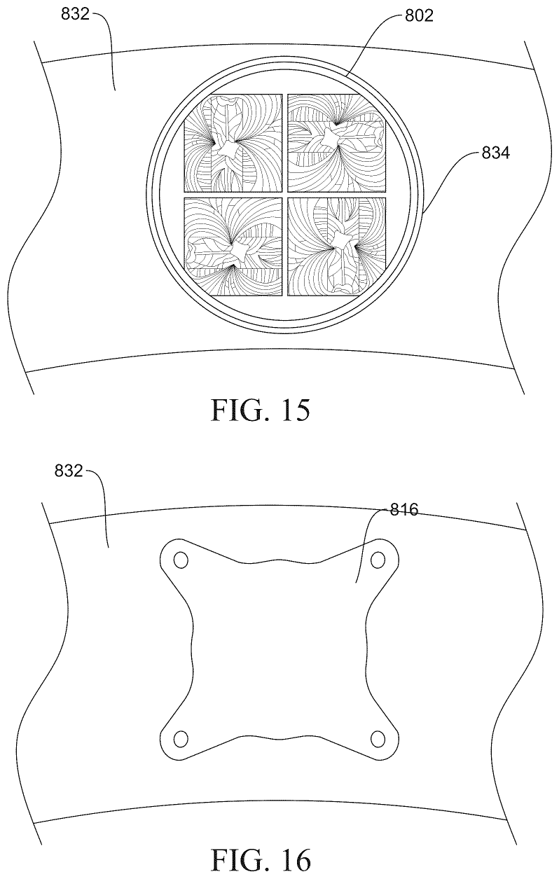

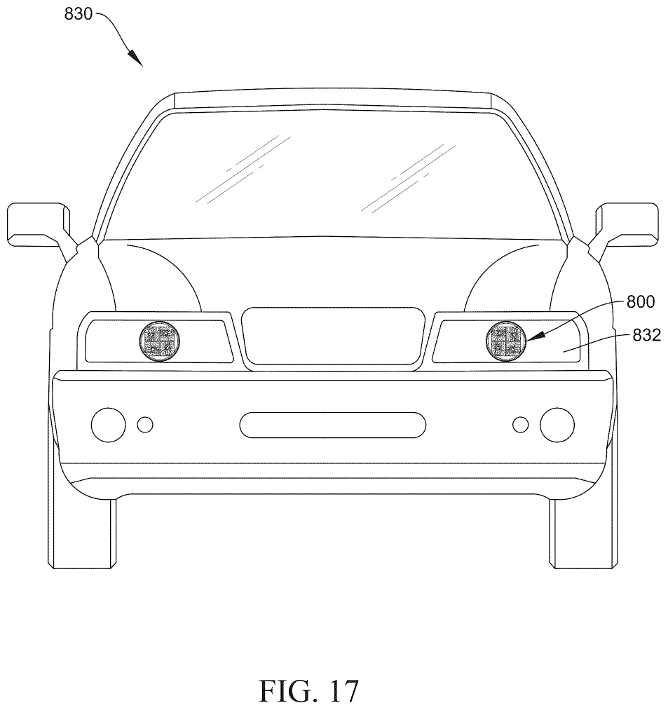

As illustrated in FIGS. 15-17, also disclosed is a vehicle 830 with an exterior component 832 having an aperture 834. The multi-optic system 800 is mounted directly to the exterior component 832 of the vehicle 830 when the unitary lens 802 is made from optical silicone. The unitary lens 802 is sized to fit within the aperture 834 such that an edge of the aperture 834 directly contacts the flexible skirt 814. The mounting substrate 816 is located internal to the exterior component 832. For example, the unitary lens 802 is pushed through the aperture from an internal vehicle side of the exterior component 832 and when in place, the mounting substrate 816 is attached to the vehicle using the attachment members 824. From outside the vehicle 830, only the unitary lens 802 is seen. The skirt 814, when made from optical silicone, is flexible and forms a gapless seal with the exterior component 832 within the aperture 834. The unitary lens 802 can be adjusted or aligned as required while in the aperture due to the flexible skirt 814 being optical silicone. The flexible skirt 814 has enough give to allow for the necessary alignment, which typically requires a movement of about 4 degrees either vertically and/or horizontally. When the unitary lens 802 is made from a material other than optical silicone, a sealing member will be required between the skirt and the aperture. The exterior component 832 may be a grill, exterior body panel, or fender, as non-limiting examples.

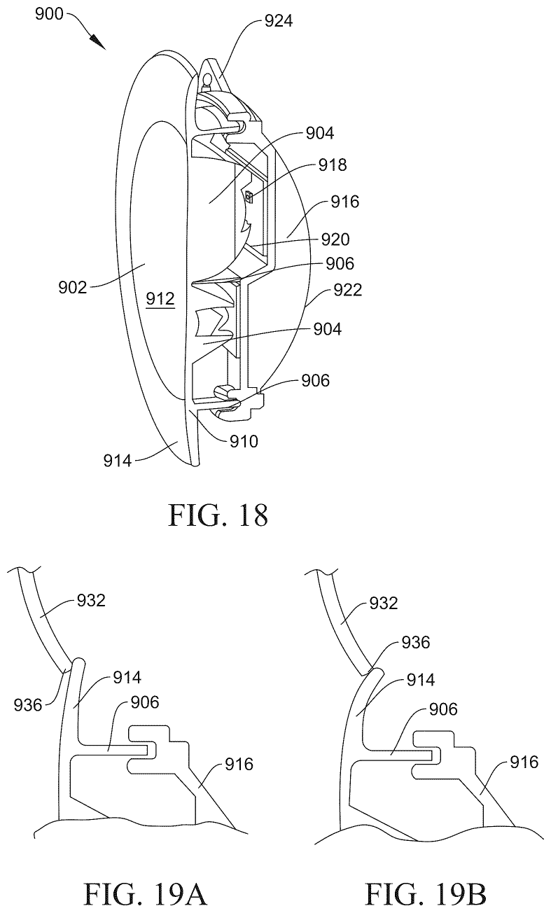

FIGS. 18, 19A and 19B illustrate another implementation of a multi-optic system 900. Similar to the other multi-optic systems disclosed herein, the multi-optic system 900 has a unitary lens 902 having two or more co-molded individual optics 904 molded such that each individual optic 904 is adjacent at least one other individual optic, each individual optic 904 configured to be illuminated with a respective radiation source. An optical-blocking barrier 906 is positioned between adjacent individual optics 904 and configured to prevent transmission of undesired source emissions between the adjacent individual optics 904. The optical-blocking barrier 906 may also be positioned around a perimeter of the two or more co-molded individual optics 904. The optical-blocking barrier may also or alternatively extend along a perimeter 910 of the unitary lens 902 to surround the two or more co-molded individual optics 904. The optical-blocking barrier 906 may have a contoured portion that is contoured to align with the internal surfaces of one or more individual optics 904, leaving a hole aligned with the light source, thereby eliminating stray light sources from the circuit board.

The unitary lens 902 may further have a skirt 914 that extends from a front surface 912 of the unitary lens 902. The skirt 914 can be molded with the co-molded individual optics 904 for form the unitary lens 902. The multi-optic system 900 may also include a mounting substrate 916 configured to carry one or more of a light source 918, a circuit board 920, and heat sink 922. The mounting substrate 916 has one or more attachment members 924. The multi-optic systems disclosed herein can be made to fit conventionally sized apertures or non-conventionally sized apertures. Examples of conventional diameters include, but are not limited to, 7″ or 4.5″ diameters of apertures.

In this implementation, the skirt 914 extends radially outward from the perimeter 910 of the front surface 912 of the unitary lens 902 and the optical-blocking barrier 906 extends rearward to the mounting substrate 916. The unitary lens 902 is sized so that the skirt 914 contacts an edge 936 of an aperture within an exterior component 932 from a vehicle side of the exterior component 932. When the unitary lens 902 is made from optical silicone, the skirt 914 is flexible and can directly contact the edge 936 of the aperture to form a gapless seal. The mounting substrate 916 is attached to the vehicle using the attachment members 924. From outside the vehicle 830, only the unitary lens 902 is seen. The unitary lens 902 can be adjusted or aligned as required while in the aperture due to the flexible skirt 914 being optical silicone. The flexible skirt 914 has enough give to allow for the necessary alignment, which typically requires a movement of about 4 degrees either vertically and/or horizontally. FIG. 19B illustrates the flexibility of the flexible skirt 914 when the multi-optic system 900 is aligned. When the unitary lens 902 is made from a material other than optical silicone, a sealing member will be required between the skirt and the aperture. The exterior component 932 may be a grill, exterior body panel, or fender, as non-limiting examples.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A multi-optic system, comprising:
a unitary lens comprising two or more co-molded individual total internal reflection (TIR) optics molded such that each individual optic is adjacent at least one other individual optic, each individual optic configured to be illuminated with a respective radiation source; and
an optical-blocking barrier positioned between the two or more co-molded individual TIR optics and around a perimeter of the two or more co-molded individual TIR optics, the optical-blocking barrier configured to interfere with transmission of undesired source emissions between the two or more co-molded individual TIR optics.

2. The multi-optic system of claim 1, wherein the unitary lens comprises three co-molded individual TIR optics, with one optic providing a low beam function for a vehicle and two optics providing a high beam function for the vehicle.

3. The multi-optic system of claim 1, wherein the unitary lens comprises four co-molded individual TIR optics, with two optics providing a low beam function for a vehicle and another two optics providing a high beam function for the vehicle.

4. The multi-optic system of claim 1, wherein the unitary lens is molded from optical silicone.

5. The multi-optic system of claim 4, wherein the unitary lens further comprises a flexible skirt of the optical silicone that extends from a front surface of the unitary lens.

6. The multi-optic system of claim 5, further comprising a mounting substrate configured to carry one or more of a light source, a circuit board, and heat sink, one or both of the flexible skirt and the optical-blocking barrier extending rearward from the front surface of the unitary lens to contact the mounting substrate to enclose the unitary lens with the mounting substrate.

7. The multi-optic system of claim 6, wherein the flexible skirt extends rearward from the front surface of the unitary lens, the optical-blocking barrier having a depth substantially equal to a depth of the flexible skirt to provide structural support to the flexible skirt.

8. The multi-optic system of claim 6, wherein flexible skirt extends radially outward from a perimeter of the front surface of the unitary lens and the optical-blocking barrier extends rearward to the mounting substrate.

9. A vehicle, comprising:
an exterior component having an aperture; and
the multi-optic system of claim 5, wherein the unitary lens is sized to fit within the aperture such that an edge of the aperture contacts the flexible skirt, the mounting substrate located internal to the exterior component.

10. The vehicle of claim 9, wherein the exterior component is a grill, body panel, or fender.

11. A multi-optic system, comprising:
a unitary lens comprising:
two or more co-molded individual optics molded such that each individual optic is adjacent at least one other individual optic, each individual optic configured to be illuminated with a respective radiation source; and
a skirt extending from a perimeter of a front surface of the unitary lens;
an optical-blocking barrier positioned between adjacent individual optics and configured to prevent transmission of undesired source emissions between adjacent individual optics; and
a substrate on which radiation sources are carried, the substrate and at least one of the skirt and the optical-blocking barrier enclosing the multi-optic system.

12. The multi-optic system of claim 11, wherein the optical-blocking barrier extends along the perimeter of the front surface to surround the two or more co-molded individual optics.

13. The multi-optic system of claim 12, wherein the skirt extends rearward from the perimeter of the front surface, the optical-blocking barrier that extends along the perimeter positioned internal to and adjacent the skirt.

14. The multi-optic system of claim 13, wherein the skirt is configured to fit within an aperture of a vehicle exterior component, the substrate configured for attachment interior to the vehicle exterior component.

15. The multi-optic system of claim 13, wherein the skirt is a flexible silicone and configured to contact an edge of an aperture in a vehicle exterior component such that the skirt is in direct contact with the vehicle exterior component, the substrate configured for attachment interior to the vehicle exterior component.

16. The multi-optic system of claim 12, wherein the skirt extends radially outward from the perimeter of the front surface while the optical-blocking barrier extends between the front surface of the unitary lens and the substrate.

17. The multi-optic system of claim 11, wherein the unitary lens comprises three co-molded individual optics, with one optic providing a low beam function for a vehicle and two optics providing a high beam function for the vehicle.

18. The multi-optic system of claim 11, wherein the unitary lens comprises four co-molded individual optics, with two optics providing a low beam function for a vehicle and another two optics providing a high beam function for the vehicle.

19. The multi-optic system of claim 11, wherein the optical-blocking barrier is inserted into the unitary lens.

20. The multi-optic system of claim 11, wherein unitary lens is molded from optical silicone.
